(19) United States
(12) Patent Application Publication
(10) Pub. No.: US 2024/0290142 A1
(43) Pub. Date: Aug. 29, 2024

(54) METHOD FOR CREATING DETERMINATION SPACES, METHOD FOR UPDATING DETERMINATION SPACE, METHOD FOR DETERMINING ROAD SURFACE STATE, DETERMINATION SPACE CREATION APPARATUS, AND ROAD SURFACE STATE DETERMINATION APPARATUS

(71) Applicants: Alps Alpine Co., Ltd., Tokyo (JP); The Yokohama Rubber Co., Ltd., Hiratsuka City (JP)

(72) Inventors: Heishiro FUDO, Miyagi-ken (JP); Shinichi SEO, Tokyo (JP); Eiji SHINOHARA, Miyagi-ken (JP); Shinya ICHISE, Miyagi-ken (JP); Nozomi ITO, Miyagi-Ken (JP); Dong gu KIM, Miyagi-ken (JP); Naoshi MIYASHITA, Kanagawa-ken (JP); Tadashi HIGUCHI, Kanagawa-ken (JP)

(21) Appl. No.: 18/660,834

(22) Filed: May 10, 2024

Related U.S. Application Data
(63) Continuation of application No. PCT/JP2022/039457, filed on Oct. 24, 2022.

(30) Foreign Application Priority Data
Dec. 16, 2021 (JP) 2021-204256

(51) Int. Cl. G07C 5/02; G01H 11/08

(52) U.S. Cl. CPC G07C 5/02; G01H 11/08

(57) ABSTRACT

A method creates determination spaces for determining a road surface state of a road surface on which a vehicle is running from output waveform data obtained by measuring changes in a physical quantity of a tire of the vehicle during the running using information regarding road surfaces and the output waveform data. The method includes obtaining the output waveform data in a plurality of different road surface states and a running condition at times of measurement of the output waveform data, classifying the output waveform data into a plurality of groups on a basis of the running condition, performing, for each group, machine learning using training data where the output waveform data is associated with information regarding the road surface states, and creating the determination space corresponding to the group.

### CLAIM OF PRIORITY

This application is a Continuation of International Application No. PCT/JP2022/039457 filed on Oct. 24, 2022, which claims benefit of Japanese Patent Application No. 2021-204256 filed on Dec. 16, 2021. The entire contents of each application noted above are hereby incorporated by reference.

### BACKGROUND OF THE INVENTION

### 1. Field of the Invention

The present invention relates to a method and an apparatus for performing machine learning on output waveform data indicating changes in physical quantities of a tire measured, using sensors, in each of road surface states with different conditions and creating determination spaces for determining a road surface state from the output waveform data, a method for updating a determination space, and a method and an apparatus for determining, using created determination spaces, a road surface state at a time when determination target data has been obtained.

### 2. Description of the Related Art

Conventionally, time-varying waveforms of vibration of tires during running are detected by vibration detection means attached to the tires and used to determine a state of a road surface that the tires are in contact with. Japanese Unexamined Patent Application Publication No. 2019-123293, for example, describes a method for determining a road surface state used to discriminate between a DRY road surface and a WET road surface using feature values of the time-varying waveforms of front wheels and discriminate between a DRY road surface and an ICE road surface, between a DRY road surface and a SNOW road surface, or between a DRY road surface and an ICE/SNOW road surface using feature values of the time-varying waveforms of rear wheels, in order to accurately and reliably determine a road surface with a small amount of calculation.

### SUMMARY OF THE INVENTION

Time-varying waveforms of vibration of tires during running, however, include noise, which is an effect of elements other than a road surface state, and it is difficult to read only an effect of the road surface state and accurately determine the road surface state.

The present invention, therefore, provides a method for creating determination spaces for determining a road surface state, a method for updating a determination space, a method for determining a road surface state, a determination space creation apparatus, and a road surface state determination apparatus capable of accurately determining a road surface state.

The present invention includes the following configurations as means for solving the above-described problem.

A method for creating determination spaces for determining a road surface state of a road surface on which a vehicle is running from output waveform data obtained by measuring changes in a physical quantity of a tire of the vehicle during the running using information regarding road surface states and the output waveform data includes obtaining the output waveform data in a plurality of different road surface states and a running condition at times of measurement of the output waveform data, classifying the output waveform data into a plurality of groups on a basis of the running condition, and performing, for each group, machine learning using training data where the output waveform data is associated with information regarding the road surface states and creating the determination space corresponding to the group.

Determination spaces capable of accurately determining a road surface state can be obtained by classifying output waveform data into a plurality of groups on the basis of a running condition and creating a determination space corresponding to each group through machine learning.

The output waveform data for each group may be normalized. The training data may be generated by associating the normalized output waveform data with the information regarding the road surface states.

By normalizing the output waveform data for each group, the output waveform data belonging to the group can be easily compared while reducing an effect of elements other than the running condition used to classify the output waveform data.

The running condition may be running speed of the vehicle and/or a wear level of the tire at the times of the measurement of the output waveform data. The groups may be defined on a basis of the running speed and/or the wear level of the tire.

Since the running speed and/or the wear level are running conditions that greatly affect output waveform data, determination spaces capable of accurately determining a road surface state can be created by classifying the output waveform data using one or both of these as indicators.

Instead of performing, for each group, the machine learning using the training data where the output waveform data belonging to the group is associated with the information regarding the road surface state, machine learning using first training data where the output waveform data is associated with the road surface states may be performed. An important area, which is an area in the output waveform data where differences tend to be caused depending on the road surface state, may be determined for each group. Important part waveform data, which is the output waveform data in the important area, may be extracted from the output waveform data. Machine learning using second training data where the important part waveform data is associated with the information regarding the road surface states may be performed for each group and the determination space corresponding to the group may be created.

By determining an important area for each group and using, for machine learning, second training data where important part waveform data in the important area is associated with information regarding the road surface state, determination spaces can be efficiently created.

The output waveform data may be an output of a piezoelectric sensor attached to an inside surface of the tire.

By using the output of the piezoelectric sensor as the output waveform data, the running conditions such as the wear level of the tire and the running speed of the vehicle can be calculated from the output waveform data.

A method for determining a road surface state from a measured value of output waveform data obtained by measuring changes in a physical quantity of a tire of a vehicle during running using one of a plurality of determination spaces created by the above-described method for creating determination spaces includes obtaining determination target data, which is the output waveform data measured in order to determine a road surface state, and a determination running condition, which is a running condition at a time of the measurement of the determination target data, selecting, from among the plurality of determination spaces, all determination spaces including the obtained determination running condition as applicable determination spaces, applying the applicable determination spaces to the determination target data, and determining the road surface state of the road surface during the running on the basis of a road surface state associated with the determination target data in the applicable determination spaces.

By applying a determination space created for each of groups defined in accordance with a running condition to determination target data, a road surface state can be accurately determined.

A method for updating a determination space includes creating new training data by associating the determination target data obtained by the above-described method for determining a road surface state with information regarding the road surface state determined by applying the method for determining a road surface state to the determination target data and updating the determination space determined to include the determination target data.

By updating determination spaces using a result of a determination of a road surface state, accuracy of determining a road surface state improves.

A determination space creation apparatus that creates determination spaces for determining a road surface state of a road surface on which a vehicle is running from output waveform data obtained by measuring changes in a physical quantity of a tire of the vehicle during the running using information regarding road surface states and the output waveform data includes a classification unit that obtains the output waveform data in a plurality of different road surface states and a running condition at times of measurement of the output waveform data and that classifies the output waveform data into a plurality of groups on a basis of the running condition and a determination space creation unit that performs, for each group, machine learning using training data where the output waveform data is associated with information regarding the road surface states and that creates the determination space corresponding to the group.

By classifying output waveform data into a plurality of groups in accordance with a running condition and creating a determination space for each group, determination spaces capable of accurately determining a road surface state can be created.

The determination space creation apparatus may further include, instead of the determination space creation unit, an important area determination section that performs machine learning using first training data where the output waveform data is associated with the road surface states and that determines, for each group, an important area, which is an area in the output waveform data where differences tend to be caused depending on the road surface state, an important part extraction section that extracts important part waveform data, which is the output waveform data in the important area, from the output waveform data, and a second determination space creation section that performs, for each group, machine learning using second training data where the important part waveform data is associated with the information regarding the road surface states and that creates the determination space corresponding to the group.

By determining an important area for each group and using, for machine learning, second training data where important part waveform data is associated with information regarding the road surface state, determination spaces can be efficiently created using data in a part of the output waveform data where differences in the road surface state can be determined more easily.

A road surface state determination apparatus that determines a road surface state from a measured value of output waveform data obtained by measuring changes in a physical quantity of a tire of a vehicle during running includes a measurement device that measures the changes in the physical quantity of the tire, a storage unit storing a plurality of determination spaces created by the method for creating determination spaces in the present invention, a determination space selection unit that obtains determination target data, which is the output waveform data measured in order to determine a road surface state, and a determination running condition, which is a running condition at a time of the measurement of the determination target data and that selects, from among the plurality of determination spaces, all determination spaces including the obtained determination running condition as applicable determination spaces, and a determination unit that determines whether each applicable determination space includes the determination target data and that determines the road surface state of the road surface during the running on a basis of information regarding a road surface state associated with the applicable determination space determined to include the determination target data.

The determination unit may obtain the running condition from vehicle equipment or calculate and obtain the running condition from the output waveform data.

A road surface state of a road surface during running can be accurately determined by creating a plurality of determination spaces, selecting determination spaces including a determination running condition as applicable determination spaces, and determining the road surface state during the running from information regarding a road surface state associated with the applicable determination spaces.

The physical quantity of the tire may include running speed of the vehicle and a wear level of the tire at the time of the measurement. The measurement device may be a piezoelectric sensor attached to an inside surface of the tire and outputs time-series data regarding deformation speed of the tire as the output waveform data. The determination unit may calculate the running speed of the vehicle from periodicity of the output waveform data and calculate the wear level of the tire from an output value.

Changes in the physical quantity of the tire over time can be accurately measured using a piezoelectric sensor as the measurement device. In addition, since the running speed and the wear level of the tire can be calculated from output waveform data from the piezoelectric sensor, the road surface state determination apparatus can be simplified.

The road surface state determination apparatus may further include an update unit capable of updating the determination spaces stored in the storage unit. The update unit may generate additional training data, which is new training data where the output waveform data used to determine the road surface state, a result of the determination of the road surface state, and the running conditions at a time of the determination of the road surface state are associated with one another, create, for a group of the training data associated with the same information as information associated with the additional training data, an update group by adding the additional training data to a group of training data used to create the determination spaces used for the determination as the applicable determination spaces, and perform machine learning on the update group and updates the determination spaces.

In this case, the road surface state determination apparatus may further include a validity evaluation unit that obtains information indicating whether the road surface state determined by the determination unit is valid and that, if the road surface state is valid, determines information regarding the road surface state determined by the determination unit as information regarding a road surface state corresponding to the measured value.

Since an update group is created and machine learning is performed on the update group to update determination spaces, determination spaces capable of accurately determining a road surface state can be obtained. In addition, by evaluating validity of a road surface state determined by the validity evaluation unit, machine learning can be performed with appropriate training data added, which improves accuracy of determining determination spaces.

Determination spaces capable of accurately determining a road surface state can be obtained by performing machine learning on each of groups defined on the basis of a running condition and creating corresponding determination spaces. A road surface state, therefore, can be accurately determined by applying the determination spaces to determination target data.

### BRIEF DESCRIPTION OF THE DRAWINGS

FIG. 1 is a flowchart of a method for creating determination spaces according to a first embodiment;

FIG. 2 is a function block diagram of a determination space creation apparatus according to the first embodiment;

FIG. 3 is a function block diagram of a determination space creation apparatus according to a second embodiment;

FIG. 4 is a flowchart of a method for creating determination spaces according to the second embodiment;

FIG. 5 is a graph schematically illustrating an important area in output waveform data;

FIG. 6 is a function block diagram of a road surface state determination apparatus;

FIG. 7 is a flowchart of a method for determining a road surface state according to a third embodiment; and

FIG. 8 is a flowchart illustrating a method for updating a determination space according to a fourth embodiment.

### DESCRIPTION OF THE PREFERRED EMBODIMENTS

Aspects for implementing the present invention will be described hereinafter with reference to the drawings. The same members are given the same member numerals in each drawing, and description thereof is omitted as appropriate.

### First Embodiment

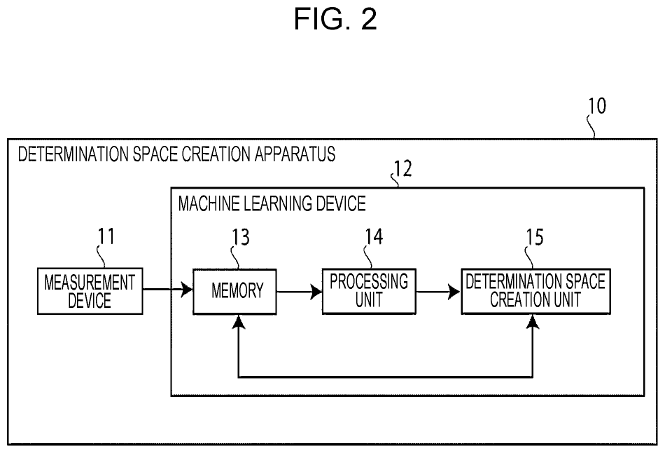

As illustrated in FIG. 2, a determination space creation apparatus 10 according to the present embodiment is an apparatus that creates determination spaces for determining a road surface state of a road surface on which a vehicle is running from output waveform data obtained by measuring changes in physical quantities of a tire of the vehicle during the running using information regarding road surface states and the output waveform data.

The determination space creation apparatus 10 includes a measurement device 11 and a machine learning device 12.

The measurement device 11 measures changes in physical quantities of a tire of a vehicle and measures output waveform data in a plurality of different road surface states. As the measurement device 11, for example, a piezoelectric sensor, an acceleration sensor, or the like may be used.

As the piezoelectric sensor, a film-shaped composite piezoelectric element where potassium niobate, sodium potassium niobate, barium titanate, or lead zirconate titanate is used as powder or a polymer piezoelectric element such as PVDF or PVDF-TrFE may be used.

The machine learning device 12 includes a memory 13, a processing unit 14, and a determination space creation unit 15 and creates determination spaces on the basis of output waveform data obtained by the measurement device 11 and information regarding road surface states and running conditions at times when the output waveform data has been obtained. The running conditions and the information regarding road surface states are obtained from devices included in a vehicle, which are not illustrated, other input devices, or the like or calculated and obtained from outputs of the measurement device 11 and stored in the memory 13.

The memory 13 stores output waveform data obtained by the measurement device 11, information regarding road surface states, and running conditions while associating the output waveform data, the information regarding road surface states, and the running conditions with one another and may be a memory such as a RAM.

The processing unit 14 classifies output waveform data into a plurality of groups on the basis of information regarding road surface states and running conditions. The running conditions refer to elements such as a vehicle and an environment outside the vehicle during running. The vehicle includes a vehicle body and components attached to the vehicle body, such as tires. The running conditions used for the classification include running speed, a wear level of a tire, atmospheric temperature, and the like. These are divided into certain numerical ranges. One running condition or a combination of a plurality of running conditions is used to classify output waveform data.

The determination space creation unit 15 creates a determination space corresponding to each group by performing machine learning for the group using training data where output waveform data is associated with information regarding a road surface state. The determination space creation unit 15 is implemented as hardware or software (program) of a computer or the like.

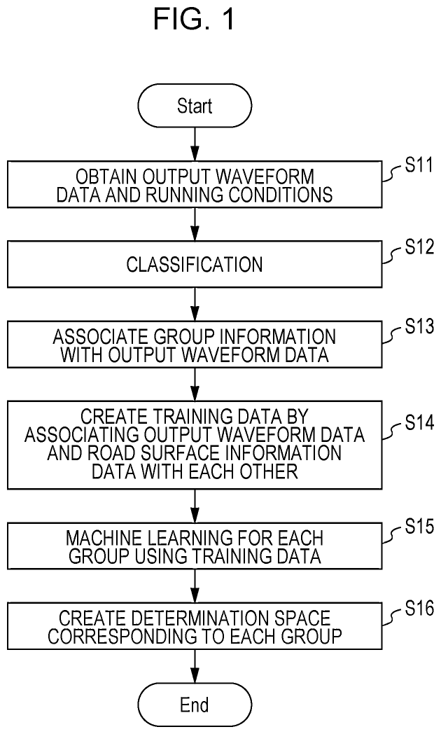

FIG. 1 is a flowchart of a method for creating determination spaces according to the present embodiment. The method for creating determination spaces according to the present embodiment is used to create determination spaces for determining a road surface state of a road surface on which a vehicle is running from output waveform data obtained by measuring changes in physical quantities of a tire of the vehicle during the running using information regarding road surface states and the output waveform data.

The determination space creation apparatus 10 obtains output waveform data for each of a plurality of different road surface states (DRY, WET, ICE, etc.) and running conditions at a time of measurement of the output waveform data (S11). The determination space creation apparatus 10 obtains running conditions of a vehicle such as running speed and a wear level of a tire from the measurement device 11 or other devices. The output waveform data obtained in S11 is stored in the memory 13 and then used for processing performed by the processing unit 14. The output waveform data may be used for the processing performed by the processing unit 14 without being stored in the memory 13, instead.

The processing unit 14 classifies the output waveform data into a plurality of groups on the basis of the running conditions of the vehicle obtained in S11 (S12). Group information is then associated with the output waveform data (S13), and the output waveform data associated with the group information and the information regarding road surface states (road surface information data) are associated with each other to create training data (S14).

Although the output waveform data and the information regarding road surface states are associated with each other in S14 in the above description of the flowchart, the association may be performed at some stage in S11 to S13. Since the measurement in S11 is performed with the road surface states known and the information regarding road surface states is already clear in S11, the above association can be performed at some stage in S11 to S13.

The determination space creation unit 15 performs machine learning for each group using the training data (S15). A determination space corresponding to each group is then created (S16). By creating a determination space corresponding to each group, that is, by creating a plurality of determination spaces as many as the number of groups, determination spaces with a high level of accuracy of determination of a road surface state can be created. When determination spaces are created by classifying output waveform data into groups including a plurality of road surface states using running conditions, each determination space is classified as a space corresponding to one of the plurality of road surface states to be determined. S15 and S16 are a so-called “training” phase of machine learning, and the determination space creation unit 15 creates “determination lines” for classifying road surface states using the determination spaces defined using the running conditions.

The output waveform data in S11 is preferably output from a piezoelectric sensor attached to an inside surface of the tire. Output waveforms of a piezoelectric sensor include a part where there is a difference in an output value between a new tire and a worn tire. Since output waveforms of a piezoelectric sensor have such a characteristic, a wear state of a tire can be estimated on the basis of output waveform data of the piezoelectric sensor.

In addition, an output of a piezoelectric sensor increases when a surface of a tire opposite a part to which the piezoelectric sensor is attached contacts the ground. That is, when a vehicle is running at a constant speed for a certain period of time, an output value increases periodically. Running speed of the vehicle, therefore, can be calculated from size of the tire and a period at which the output increases. When the determination space creation unit 15 estimates a wear state, information regarding a running speed or the like may be obtained from vehicle equipment or the like. On a sunny day when a road surface is dry (DRY), the wear state of the tire can be accurately estimated on the basis of output waveform data of the piezoelectric sensor.

The running conditions in S11 may be, for example, the running speed of the vehicle and/or the wear level of the tire at a time of the measurement of the output waveform data. When these have been obtained as the running conditions, the machine learning in S15 and the creation of a determination space in S16 are performed for each of the groups defined on the basis of either the running speed of the vehicle or the wear level of the tire or both the running speed of the vehicle and the wear level of the tire. The running speed and/or the wear level, which are the running conditions of the vehicle, are elements that greatly affect output waveform data. By using one or both of these as indicators for classifying output waveform data into groups, therefore, determination spaces capable of accurately determining a road surface state can be created.

The following table shows a model for creating determination spaces. In the creation of determination spaces, output waveform data is measured in each of ranges defined in accordance with certain wear levels and certain running speeds with a road surface state known in advance. Table 1 shows an example where output waveform data was measured under certain running conditions for each road surface state with a range of the wear level of higher than or equal to 0 to lower than or equal to 50% defined as a low wear level, a range of the wear level of the tire of higher than 50% to lower than or equal to 100% defined as a high wear level, a range of the running speed of the vehicle of higher than 0 km/h and lower than or equal to 40 km/h defined as a low running speed, and a range of the running speed of the vehicle of higher than 40 km/h and lower than or equal to 100 km defined as a high running speed. Although table 1 includes two road surface states, namely DRY (dry state) and WET (wet state), classifications of the road surface state are not limited to these. For example, WET may include two or more levels in accordance with how wet a road surface is, and ICE (frozen state) may also be added, instead. In addition, the wear level and the running speed as the running conditions may also be divided into three or more ranges.

TABLE 1

| Road | Running Conditions | | |
|---|---|---|---|
| Surface | Wear | Running | |
| State | Level | Speed | Output Waveform Data |
| DRY | Low | Low | (1) DSL1, DSL2, . . . , DSLn |
| | | High | (2) DSH1, DSH2, . . . , DSHn |
| | High | Low | (3) DLL1, DLL2, . . . , DLLn |
| | | High | (4) DLH1, DLH2, . . . , DLHn |
| WET | Low | Low | (5) WSL1, WSL2, . . . , WSLn |
| | | High | (6) WSH1, WSH2, . . . , WSHn |
| | High | Low | (7) WLL1, WLL2, . . . , WLLn |
| | | High | (8) WLH1, WLH2, . . . , WLHn |

As indicated by table 1, output waveform data (1) DSL1, DSL2, . . . . DSLn is measured in the road surface state DRY with the low wear level and the low running speed as the running conditions. Output waveform data (2) to (8) is also measured similarly in the road surface state DRY with other combinations of measurement conditions or in the road surface state WET with various running conditions.

The output waveform data measured as above is classified into a plurality of groups on the basis of the running conditions, and a determination space for distinguishing between the road surface states DRY and WET is created for each group through machine learning.

When the output waveform data is classified into groups including a plurality of road surface states using running conditions and the output waveform data is classified on the basis of only the wear level, the output waveform data is divided into two groups of (1), (2), (5), and (6) and (3), (4), (7), and (8). When the output waveform data is classified on the basis of the running speed, the output waveform data is divided into two groups of (1), (3), (5), and (7) and (2), (4), (6), and (8). When the output waveform data is classified on the basis of the wear level and the running speed, the output waveform data is classified into four groups of (1) and (5), (2) and (6), (3) and (7), and (4) and (8).

In the method for creating determination spaces according to the present embodiment, determination spaces are not created using all of obtained output waveform data as training data as is but created by, as illustrated in FIG. 1, classifying obtained output waveform data on the basis of the running conditions and performing machine learning for each of groups into which the output waveform data has been classified. As a result, determination spaces with a high level of determination accuracy where an effect of noise caused by the running conditions upon output waveform data is reduced can be obtained.

When groups based on the wear level and the running speed have been defined and data with the high wear level and the low running speed is obtained as determination target data, for example, a group of (3) and (7), whose wear level is high and running speed is low, is selected first from among the four determination spaces. A road surface state can be accurately determined by making a determination using determination spaces corresponding to running conditions at a time of measurement of determination target data.

### Second Embodiment

A method for creating determination spaces according to the present embodiment is different from that according to the first embodiment in that output waveform data is normalized for each group and training data is generated by associating the normalized output waveform data with information regarding a road surface state and in that a determination space corresponding to each group is created by, instead of performing, for the group, machine learning using training data where the output waveform data belonging to the group is associated with information regarding a road surface state, performing machine learning using first training data where the output waveform data is associated with a road surface state, determining, for the group, an important area, which is an area in the output waveform data where differences tend to be caused depending on a road surface state, extracting important part waveform data, which is output waveform data in the important area, from the output waveform data, and performing, for the group, machine learning using second training data where the important part waveform data is associated with information regarding the road surface state.

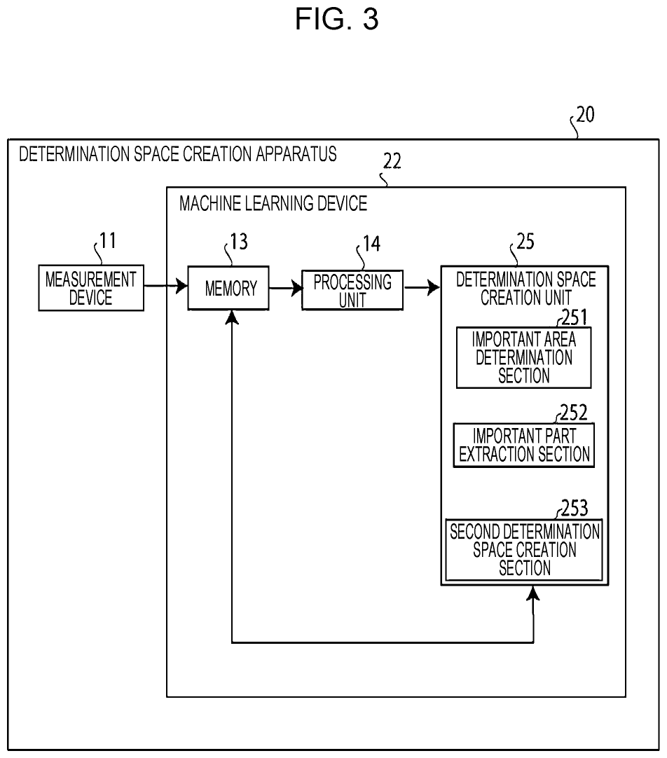

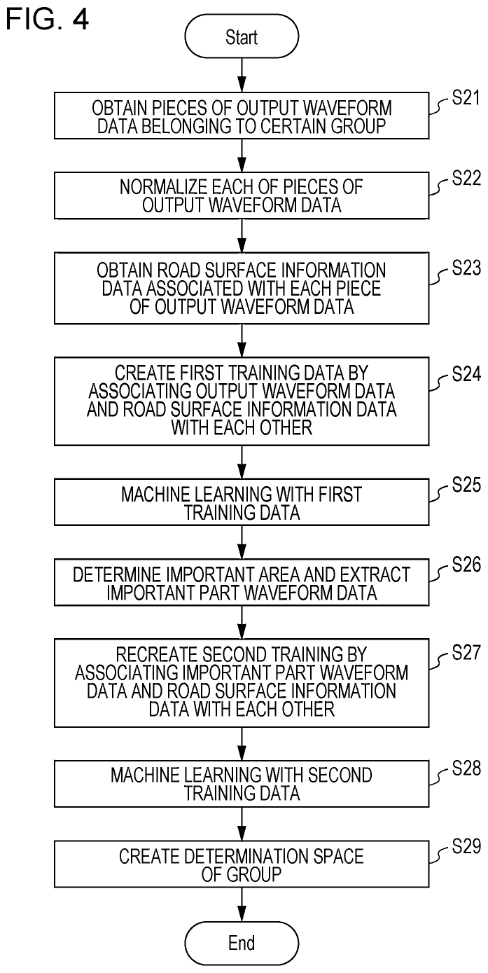

FIG. 3 is a function block diagram of a determination space creation apparatus 20 according to the present embodiment. The determination space creation apparatus 20 is different from the determination space creation apparatus 10 in that a determination space creation unit 25 of a machine learning device 22 in the determination space creation apparatus 20 includes an important area determination section 251, an important part extraction section 252, and a second determination space creation section 253. A function of each component will be described with reference to a flowchart of FIG. 4.

FIG. 4 is a flowchart of a method for creating determination spaces according to the present embodiment. The processing unit 14 obtains pieces of output waveform data belonging to certain groups (S21). Each of the pieces of output waveform data obtained in S21 is then normalized for each group (S22). In the normalization of each piece of output waveform data, the piece of output waveform data is converted with a maximum value and a minimum value of the piece of output waveform data set at 1 and 0, respectively, so that values in-between are distributed proportionally. The pieces of output waveform data are obtained from the measurement device 11 or the memory 13.

The determination space creation unit 25 obtains road surface information data associated with each of the normalized pieces of output waveform data (S23), generates first training data where the normalized pieces of output waveform data and the information regarding road surface states are associated with each other (S24), and performs machine learning using the first training data created in S24 (S25).

The determination space creation unit 25 determines, using the important area determination section 251, an important area, which is an area (a part or a range) in the output waveform data where differences tend to be caused depending on the road surface state, for each group on the basis of a result of the machine learning and extracts, using the important part extraction section 252, important part waveform data, which is the output waveform data in the important area, from the output waveform data (S26).

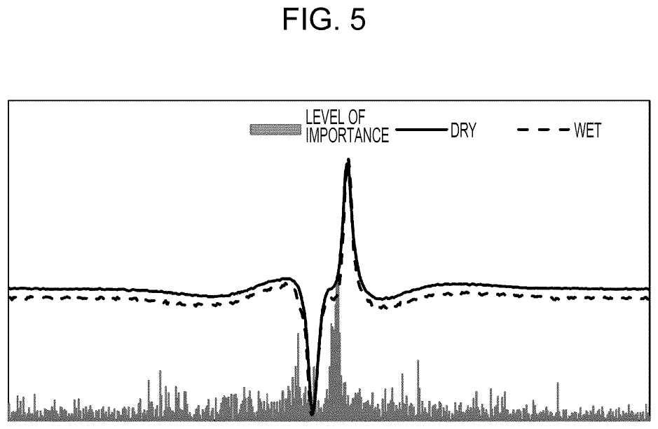

FIG. 5 is a graph schematically illustrating an important area in output waveform data. In the figure, a difference in the output waveform data due to the road surface state (DRY or WET) and a level of importance are illustrated. The level of importance indicate how greatly the road surface state affects the output waveform data. The important area determination section 251 determines an important area in output waveform data on the basis of the level of importance, and the important part extraction section 252 extracts important part waveform data. That is, the determination space creation unit 25 extracts important part waveform data by creating an important area extractor having a function of extracting an important area in a group and applying the important area extractor to output waveform data.

The second determination space creation section 253 recreates second training data where the important part waveform data extracted by the important part extraction section 252 and the information regarding road surface states (road surface information data) are associated with each other (S27). Machine learning based on the second training data is then performed for each group (S28), and a determination space corresponding to each group is created (S29).

As described above, in the method for creating determination spaces according to the present embodiment, data regarding an important area extracted from output waveform data normalized for each group is subjected to machine learning, and nonlinear spaces (determination spaces) used to determine a road surface state are created. By normalizing the output waveform data, not absolute values but relative changes in waveforms can be easily compared with one another. Through the normalization, for example, a plurality of pieces of output waveform data measured under conditions where tire temperature is different can be easily compared with one another. Data regarding waveforms in a part of the output waveform data where differences in the road surface state can be determined more easily is then extracted, and machine learning is performed using this important part waveform data. As a result, determination spaces can be efficiently created. In addition, by using the important part waveform data for the machine learning, it is possible to prevent determination spaces from being created as local optimum parts.

### Third Embodiment

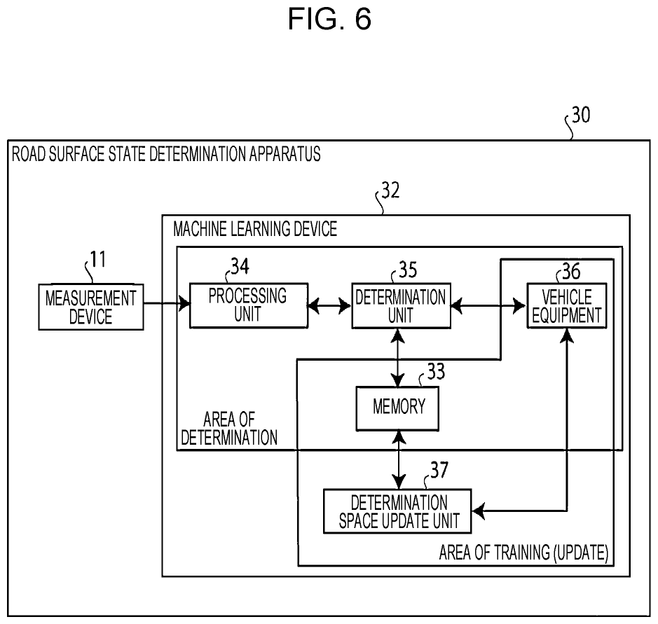

FIG. 6 is a function block diagram of a road surface state determination apparatus 30 according to the present embodiment. The road surface state determination apparatus 30 is an apparatus that determines a road surface state from measured values of output waveform data obtained by measuring changes in physical quantities of a tire of a vehicle during running and includes the measurement device 11 and a machine learning device 32.

The machine learning device 32 includes a memory 33, a processing unit 34, a determination unit 35, vehicle equipment 36, and a determination space update unit 37. The memory 33 stores a plurality of determination spaces created by the method for creating determination spaces in the present invention.

The processing unit 34 obtains determination target data, which is output waveform data measured in order to determine a road surface state, and determination running conditions, which are running conditions at a time of the measurement of the determination target data, and selects, from among a plurality of determination spaces, all determination spaces including the obtained determination running conditions as applicable determination spaces.

The determination unit 35 determines whether each of applicable determination spaces includes determination target data and then determines a road surface state of a road surface during running from information regarding a road surface state associated with the applicable determination space determined to include the determination target data.

The determination unit 35 can obtain running conditions from the vehicle equipment 36 or calculate and obtain running conditions from output waveform data in the memory 33. For example, the determination unit 35 obtains running speed of a vehicle from the vehicle equipment 36 and obtains information regarding temporal deformation of a tire from an output of a piezoelectric sensor provided on an inside surface of the tire as the measurement device 11. The vehicle equipment 36 is, for example, an onboard meter that measures running speed of a vehicle, an onboard or portable device capable of connecting to the Internet and obtaining various pieces of information.

When the physical quantities of the tire are running speed of the vehicle and a wear level of the tire at a time of measurement of the physical quantities by the measurement device 11, a piezoelectric sensor attached to an inside surface of the tire is preferably used. The determination unit 35 can calculate the running speed of the vehicle from periodicity of output waveform data using time-series data regarding deformation speed of the tire output from the piezoelectric sensor as the output waveform data and then calculate the wear level of the tire from an output value. In this case, therefore, the running speed of the vehicle and the wear level of the tire can be obtained on the basis of an output of the measurement device 11 without using the vehicle equipment 36.

The determination space update unit 37 can update determination spaces stored in the memory 33 and is achieved by hardware or software (program) of a computer or the like. The determination space update unit 37 generates additional training data, which is new training data where determination target data, which is output waveform data used to determine a road surface state, a result of the determination of the road surface state, and running conditions at a time of the determination of the road surface state are associated with one another. An update group is created by adding the additional training data to a group of training data associated with the same running conditions as those associated with the additional training data. The group of training data to which the additional training data is added was used to create a determination space used to determine the road surface state on the basis of the determination target data when the additional training data was generated. Additional training data is thus added to training data associated with the same running conditions. Machine learning is then performed on the update group to update a determination space.

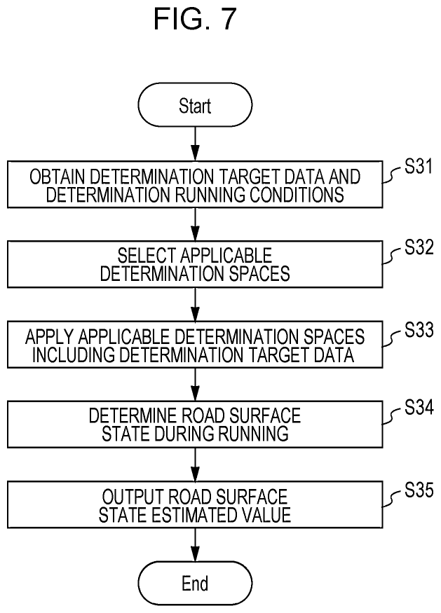

FIG. 7 is a flowchart illustrating a method for determining a road surface state according to the present embodiment. In the method for determining a road surface state according to the present embodiment, a road surface state is determined from measured values of output waveform data obtained by measuring changes in physical quantities of a tire of a vehicle during running using one of a plurality of determination spaces created by the method for creating determination spaces described in the above-described first or second embodiment.

The processing unit 34 obtains determination target data and determination running conditions, which are running conditions at a time of measurement of the determination target data (S31). The determination target data in S31 is output waveform data measured by the measurement device 11 in order to determine a road surface state, and the determination running conditions in S31 are running conditions at a time of measurement of the determination target data.

The determination unit 35 selects, from among a plurality of determination spaces created by the method for creating determination spaces, all determination spaces including the obtained determination running conditions as applicable determination spaces (S32). The determination unit 35 then applies the applicable determination spaces selected in S32 to the determination target data (S33). The determination unit 35 determines a road surface state of a road surface during running on the basis of road surface states associated in the applicable determination spaces applied in S33 with the determination target data (S34). The determination unit 35 then outputs a road surface state estimated value determined in S34 (S35). The output road surface state estimated value is, for example, transmitted to a display device of the vehicle or a mobile information terminal that does not belong to the vehicle, such as a smartphone.

When determination spaces are created while defining groups including a plurality of road surface states, the determination unit 35 applies the applicable determination spaces selected in S32 to the determination target data (S33) and determines a road surface state in accordance with which areas of the determination spaces include the determination target data (S34).

### Fourth Embodiment

In an update method according to the present embodiment, new training data is created by associating information regarding a road surface state determined by applying the method for determining a road surface state to determination target data obtained by the method for determining a road surface state according to the third embodiment with the determination target data, and a determination space determined to include the determination target data is updated using the new training data.

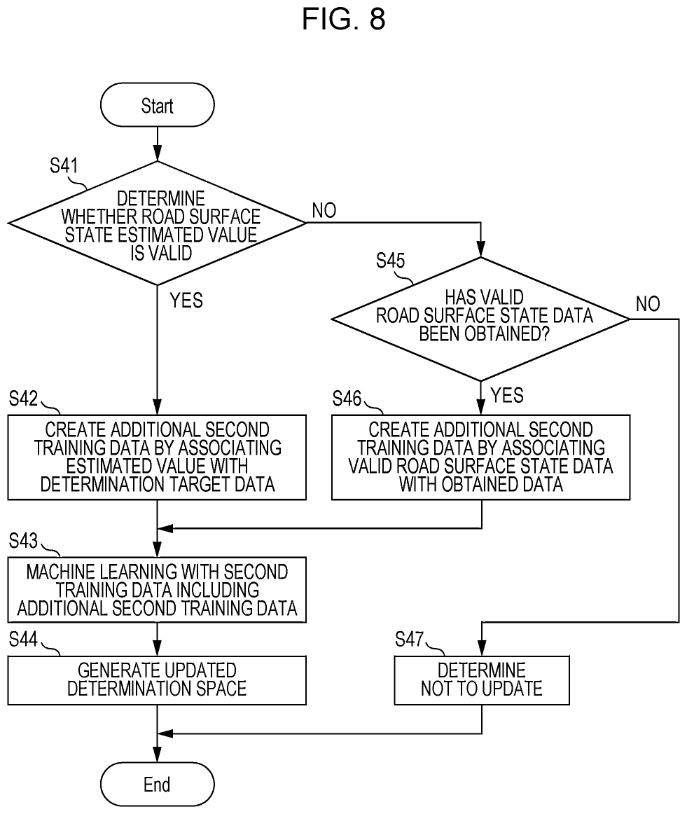

FIG. 8 is a flowchart illustrating the method for updating a determination space according to the present embodiment. As illustrated in the figure, first, whether an estimated value obtained by the method for determining a road surface state is valid is determined (S41). If determination target data is obtained and a road surface state is estimated with the road surface state known in advance, for example, an evaluator can determine validity of the road surface state estimated value. Alternatively, the determination space update unit 37 in the road surface state determination apparatus 30 may make the determination. In this case, the determination space update unit 37 may obtain external conditions (atmospheric temperature etc.) at a time of the determination from the vehicle equipment 36 and make the determination by comparing the obtained external conditions and the estimated value.

If it is determined in S41 that the estimated value is valid (YES), the determination space update unit 37 creates additional second training data by associating the road surface state estimated value with the determination target data (S42). Machine learning is then performed with the second training data including the additional second training data (S43). An updated determination space is generated on the basis of a result of the machine learning in S43 (S44). The generated updated determination space is stored in the memory 33.

If it is determined in S41 that the estimate value is not valid (NO), the determination space update unit 37 determines whether valid road surface information data can be obtained (S45). If the evaluator can input a valid road surface state (YES in S45), for example, additional second training data is created by associating the valid road surface information data with the obtained data (S46). The above-described machine learning (S43) is then performed to generate an updated determination space (S44). If the evaluator cannot input a valid road surface state (NO in S45), it is determined that the updated determination space is not used to update the determination space (S47).

In the road surface state determination apparatus 30, the memory 33, the processing unit 34, the determination unit 35, and the vehicle equipment 36 form an area for determining a road surface state corresponding to determination target data. The memory 33, the vehicle equipment 36, and the determination space update unit 37, on the other hand, form an area for updating training data using determination target data and training (updating) determination spaces using the training data.

By feeding back measured determination target data, updating training data, and training determination spaces using the training data as in the update method according to the present embodiment, determination accuracy of the determination spaces improves.

### EXAMPLE

### Creation of Determination Spaces

A vehicle ran in a test course in the following road surface states under the following running conditions, and, as output waveform data, output waveform data that was time-series data regarding deformation speed of a tire was measured using a piezoelectric sensor attached to an inside surface of the tire.

The output waveform data was divided into six groups including a plurality of road surface states on the basis of running speed of the vehicle and a wear level of the tire at a time of the measurement of the output waveform data, and the output waveform data was normalized for each group to create determination spaces. In addition, important part waveform data was extracted from the output waveform data, the output waveform data was divided into six groups including a plurality of road surface states on the basis of the running speed of the vehicle and the wear level of the tire, and the important part waveform data was normalized for each group to create determination spaces.

The road surface states are as follows:
DRY: Dry road surface (reproduction of a road surface in sunny weather)
WET0: Wet road surface without running water (reproduction of a road surface after rain)
WET1: Road surface with a small amount of running water (reproduction of a road surface in rainy weather)
WET2: Road surface with a large amount of running water (reproduction of a road surface in heavy rain)

The running conditions are as follows:
Wear Levels: 0%, 50%, 100%
Vehicle Speeds: 31 to 40 kpH (km/h), 45 to 60 kpH (km/h)

The road surface states WET0, WET1, and WET2 corresponded to three levels of a water quantity switch button for controlling a sprinkler system that could be used when the vehicle ran on the test course. It was estimated that WET1 corresponded to a road surface state in light rain of about 10 mm per hour and WET2 corresponded to a road surface state in heavy rain of more than 10 mm to about 50 mm per hour.

### <Determination of Road Surface State Based on Determination Target Data>

### Grouping:

Determination target data regarding the vehicle running on the test course was measured, determination running conditions at the time were obtained, determination spaces including the determination running conditions were selected from among the determination spaces created in accordance with the six groups as applicable determination spaces, and a road surface state was determined on the basis of the determination target data.

### Important Part:

A road surface state was determined on the basis of important part waveform data extracted from output waveform data using the same method as for the above-described determination target data using the important part waveform data instead of the output waveform data.

Comparative Example, “as Is” without Grouping:

A road surface state was determined on the basis of the same determination target data as in the example using determination spaces created using the same output waveform data as in the example as is without grouping the output waveform data by the running conditions.

### Results:

The following tables show results of the examples (grouping, important part) and the comparative example (“As Is” without grouping).

TABLE 2
Grouping

Determination Result

| | | DRY | WET0 | WET1 | WET2 |
|---|---|---|---|---|---|
| Actual | DRY | 1249 | 76 | 62 | 22 |
| Road | WET0 | 331 | 149 | 46 | 9 |
| Surface | WET1 | 280 | 51 | 172 | 15 |
| State | WET2 | 186 | 47 | 78 | 42 |

TABLE 3
Important Part

Determination Result

| | | DRY | WET0 | WET1 | WET2 |
|---|---|---|---|---|---|
| Actual | DRY | 1258 | 72 | 61 | 18 |
| Road | WET0 | 335 | 144 | 47 | 9 |
| Surface | WET1 | 279 | 52 | 173 | 14 |
| State | WET2 | 179 | 50 | 83 | 41 |

TABLE 4
“As Is” without Grouping

Determination Result

| | | DRY | WET0 | WET1 | WET2 |
|---|---|---|---|---|---|
| Actual | DRY | 1385 | 0 | 24 | 0 |
| Road | WET0 | 524 | 0 | 11 | 0 |
| Surface | WET1 | 279 | 0 | 38 | 0 |
| State | WET2 | 179 | 0 | 33 | 0 |

In the example, a “classification method that employs a linear function (support vector machine (linear kernel))” was used as the classification method in order to show an effect of the grouping. Accuracy varies if another method such as a neural network is used as the classification method. It is therefore important to improve the accuracy through grouping.

It can be seen from tables 2 to 4 that the accuracy with respect to road surface states improved by using determination spaces grouped on the basis of the running conditions. In the example shown in table 2, the classifications of WET could be distinguished from one another to some degree. In the comparative example shown in table 4, on the other hand, WET0 and WET2 could not be distinguished from each other at all and were simply incorporated into DRY, whose amount of data was large.

As indicated by tables 2 and 3, when important part waveform data was used, too, determination results similar to when output waveform data was used were obtained. It was found from this that when the amount of calculation was reduced using important part waveform data, too, road surface states could be accurately determined by using grouped determination spaces. Use of important part waveform data can contribute to improving generalized performance for accurately determining road surface states on roads other than the test course, such as public roads.

### <Example of Application to Detection of Tire Wear>

Determination spaces used for purposes other than determination (distinction) of road surface states may be created using the method for creating determination spaces according to the first embodiment. For example, output waveform data may be classified into a plurality of groups on the basis of running conditions, machine learning may be performed for each group using training data where the output waveform data is associated with information regarding wear states of a tire, and a determination space for determining a wear state of the tire may be crated for each group, instead.

An example of a method for determining a wear state, which is used to determine (distinguish) a wear state of a tire from output waveform data, which is determination target data, using determination spaces for determining the wear state of the tire, will be described hereinafter.

A measurement device performs measurement to obtain determination target data in a state where it is clear that a road surface state is dry, such as on a sunny day, and information regarding running speed can be obtained from an onboard meter. All determination spaces including determination running conditions (a road surface state and running speed here) of the determination target data are determined as applicable determination spaces, and which application determination space includes the determination target data is then determined.

A wear state of a tire is determined from information regarding a wear state of a tire associated with the applicable determination space selected in the above determination. By dividing the wear state of the tire into smaller groups when determination spaces are created, a more precise wear state can be determined. When a driver of a vehicle presses a determination start button in a state where it is clear that a road surface is dry, for example, a wear state can be determined by the method for determining a wear state in this application example.

The present invention is effective as an apparatus or a method for determining a road surface state on the basis of a result of measurement of a state of a tire during running.

What is claimed is:

1. A method for creating determination spaces for determining a road surface state of a road surface on which a vehicle is running from output waveform data obtained by measuring changes in a physical quantity of a tire of the vehicle during the running using information regarding road surface states and the output waveform data, the method comprising:
obtaining the output waveform data in a plurality of different road surface states and a running condition at times of measurement of the output waveform data;
classifying the output waveform data into a plurality of groups on a basis of the running condition; and
performing, for each group, machine learning using training data where the output waveform data is associated with information regarding the road surface states and creating the determination space corresponding to the group.

2. The method for creating determination spaces according to claim 1, further comprising:
normalizing the output waveform data for each group,
wherein the training data is generated by associating the normalized output waveform data with the information regarding the road surface states.

3. The method for creating determination spaces according to claim 1,
wherein the running condition is running speed of the vehicle and/or a wear level of the tire at the times of the measurement of the output waveform data, and
wherein the groups are defined on a basis of the running speed and/or the wear level of the tire.

4. The method for creating determination spaces according to claim 1, further comprising, instead of performing, for each group, the machine learning using the training data where the output waveform data belonging to the group is associated with the information regarding the road surface states:
performing machine learning using first training data where the output waveform data is associated with the road surface states and determining, for each group, an important area, which is an area in the output waveform data where differences tend to be caused depending on the road surface state;
extracting important part waveform data, which is the output waveform data in the important area, from the output waveform data; and
performing, for each group, machine learning using second training data where the important part waveform data is associated with the information regarding the road surface states and creating the determination space corresponding to the group.

5. The method for creating determination spaces according to claim 1,
wherein the output waveform data is an output of a piezoelectric sensor attached to an inside surface of the tire.

6. A method for determining a road surface state from a measured value of output waveform data obtained by measuring changes in a physical quantity of a tire of a vehicle during running using one of a plurality of determination spaces created by the method for creating determination spaces according to claim 1, the method for determining a road surface state comprising:
obtaining determination target data, which is the output waveform data measured in order to determine a road surface state, and a determination running condition, which is a running condition at a time of the measurement of the determination target data;
selecting, from among the plurality of determination spaces, all determination spaces including the obtained determination running condition as applicable determination spaces;
applying the applicable determination spaces to the determination target data; and
determining the road surface state of the road surface during the running on the basis of a road surface state associated with the determination target data in the applicable determination spaces.

7. A method for updating a determination space, the method comprising:
creating new training data by associating the determination target data obtained by the method for determining a road surface state according to claim 6 with information regarding the road surface state determined by applying the method for determining a road surface state to the determination target data and updating the determination space determined to include the determination target data.

8. A determination space creation apparatus that creates determination spaces for determining a road surface state of a road surface on which a vehicle is running from output waveform data obtained by measuring changes in a physical quantity of a tire of the vehicle during the running using information regarding road surface states and the output waveform data, the determination space creation apparatus comprising:
a classification unit that obtains the output waveform data in a plurality of different road surface states and a running condition at times of measurement of the output waveform data and that classifies the output waveform data into a plurality of groups on a basis of the running condition; and
a determination space creation unit that performs, for each group, machine learning using training data where the output waveform data is associated with information regarding the road surface states and that creates the determination space corresponding to the group.

9. The determination space creation apparatus according to claim 8, further comprising, instead of the determination space creation unit:
an important area determination section that performs machine learning using first training data where the output waveform data is associated with the road surface states and that determines, for each group, an important area, which is an area in the output waveform data where differences tend to be caused depending on the road surface state;
an important part extraction section that extracts important part waveform data, which is the output waveform data in the important area, from the output waveform data; and
a second determination space creation section that performs, for each group, machine learning using second training data where the important part waveform data is associated with the information regarding the road surface states and that creates the determination space corresponding to the group.

10. A road surface state determination apparatus that determines a road surface state from a measured value of output waveform data obtained by measuring changes in a physical quantity of a tire of a vehicle during running, the road surface state determination apparatus comprising:
a measurement device that measures the changes in the physical quantity of the tire;
a storage unit storing a plurality of determination spaces created by the method for creating determination spaces according to claim 1,
a determination space selection unit that obtains determination target data, which is the output waveform data measured in order to determine a road surface state, and a determination running condition, which is a running condition at a time of the measurement of the determination target data and that selects, from among the plurality of determination spaces, all determination spaces including the obtained determination running condition as applicable determination spaces; and
a determination unit that determines whether each applicable determination space includes the determination target data and that determines the road surface state of the road surface during the running on a basis of information regarding a road surface state associated with the applicable determination space determined to include the determination target data.

11. The road surface state determination apparatus according to claim 10,
wherein the determination unit obtains the running condition from vehicle equipment or calculates and obtains the running condition from the output waveform data.

12. The road surface state determination apparatus according to claim 10,
wherein the physical quantity of the tire includes running speed of the vehicle and a wear level of the tire at the time of the measurement,
wherein the measurement device is a piezoelectric sensor attached to an inside surface of the tire and outputs time-series data regarding deformation speed of the tire as the output waveform data, and
wherein the determination unit calculates the running speed of the vehicle from periodicity of the output waveform data and calculates the wear level of the tire from an output value.

13. The road surface state determination apparatus according to claim 10, further comprising:
an update unit capable of updating the determination spaces stored in the storage unit,
wherein the update unit
generates additional training data, which is new training data where the output waveform data used to determine the road surface state, a result of the determination of the road surface state, and the running conditions at a time of the determination of the road surface state are associated with one another,
creates, for a group of the training data associated with the same information as information associated with the additional training data, an update group by adding the additional training data to a group of training data used to create the determination spaces used for the determination as the applicable determination spaces, and
performs machine learning on the update group and updates the determination spaces.

14. The road surface state determination apparatus according to claim 13, further comprising:
a validity evaluation unit that obtains information indicating whether the road surface state determined by the determination unit is valid and that, if the road surface state is valid, determines information regarding the road surface state determined by the determination unit as information regarding a road surface state corresponding to the measured value.
